(19) United States
(12) Patent Application Publication
(10) Pub. No.: US 2015/0095059 A1
(43) Pub. Date: Apr. 2, 2015

(54) PROVIDER DRIVEN MODEL REMOTE HEALTHCARE MONITORING AND BILLING SYSTEM

(71) Applicant: 1Comm Medical, Inc., Ankeny, IA (US)

(72) Inventors: Scott D. Yegge, Ankeny, IA (US); Teresa A. Sieck, Ankeny, IA (US); Lucas A. Bland, Ankeny, IA (US); Scott A. Wallace, Ankeny, IA (US)

(21) Appl. No.: 14/504,662

(22) Filed: Oct. 2, 2014

Related U.S. Application Data
(60) Provisional application No. 61/885,732, filed on Oct. 2, 2013.

(51) Int. Cl. G06F 19/00; G06Q 50/22; G06Q 20/02

(52) U.S. Cl. CPC G06F 19/3418; G06F 19/328; G06Q 20/023; G06Q 50/22
USPC 705/2

(57) ABSTRACT

A healthcare monitoring and billing system having a practice management system connected to a third party facilitator system. A remote testing device is assigned to a patient that automatically transmits test results upon completion. Once reviewed by a healthcare provider a claim and billing request are automatically sent to a healthcare clearing house.

### CROSS REFERENCE TO RELATED APPLICATION

This application claims the benefit of U.S. Provisional Application No. 61/885,732 filed Oct. 2, 2013.

### BACKGROUND OF THE INVENTION

This invention is directed to a remote healthcare monitoring system, and more particularly a remote healthcare monitoring system that provides greater incentive for healthcare provider use.

Remote healthcare monitoring is known in the art. While known, current systems require outside testing companies and lack Patient-Provider accountability. Due to an inefficient model of care and delivery and a disconnect between the patient and provider, new remote monitoring systems are lended opportunity. Despite proven benefits for home monitoring, providers to date have been reserved with the current offerings. The new proposed provider driven model of delivery and management contains costs, encourages accountability, and improves quality. Due to the limited enrollment in home monitoring there exists a need in the art for a remote healthcare monitoring system that addresses these deficiencies and targets the provider and patient in a joint driving force. The provider and patient are engaged in an accountable fashion when the PROVIDER DRIVEN MODEL of delivery and management are implemented.

Thus, an objective of the present invention is to provide a remote healthcare monitoring system that improves upon the state of the art.

Another object of the present invention is to provide a remote healthcare monitoring system that is easier to use by healthcare providers and patients.

Yet another object of the present invention is to provide a remote healthcare monitoring system that offers more efficient enrollment, data transfer and tracking system.

Another object of the present invention is to provide a remote healthcare monitoring system that contains costs.

Yet another object of the present invention is to provide a remote healthcare monitoring system that automates billing.

Another object of the present invention is to provide a remote healthcare monitoring system that engages the patient and provider to strengthen accountability.

A further objective of the present invention is to provide a remote healthcare monitoring system that creates tracking of clinical and financial outcomes for a healthcare provider or healthcare system.

### BRIEF SUMMARY OF THE INVENTION

A provider driven model remote healthcare monitoring and billing system has a practice management system operated by a health care provider that is connected via an electronic network to a third party facilitator system. The health care provider assigns a remote testing device to a patient with predetermined testing protocols. Upon completion of a test, results are automatically transmitted to the third party facilitator system and/or the practice management system.

Once the test results have been reviewed by the healthcare provider the third party facilitator system determines in billing guidelines have been met and automatically sends a claim request and a billing claim to a healthcare clearing house. The health care clearing house processes the requests and transfers payment to the healthcare provider.

### BRIEF DESCRIPTION OF THE DRAWINGS

FIG. 1 is a schematic view of a healthcare monitoring and billing system; and

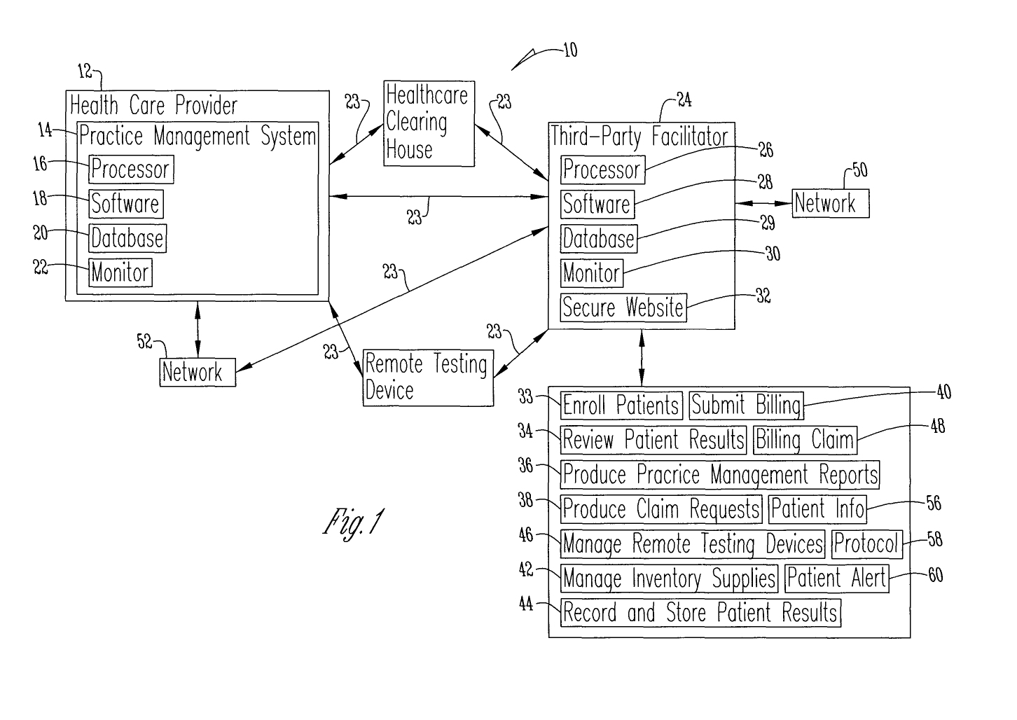

FIG. 2 is a flow diagram of a method of monitoring and billing healthcare

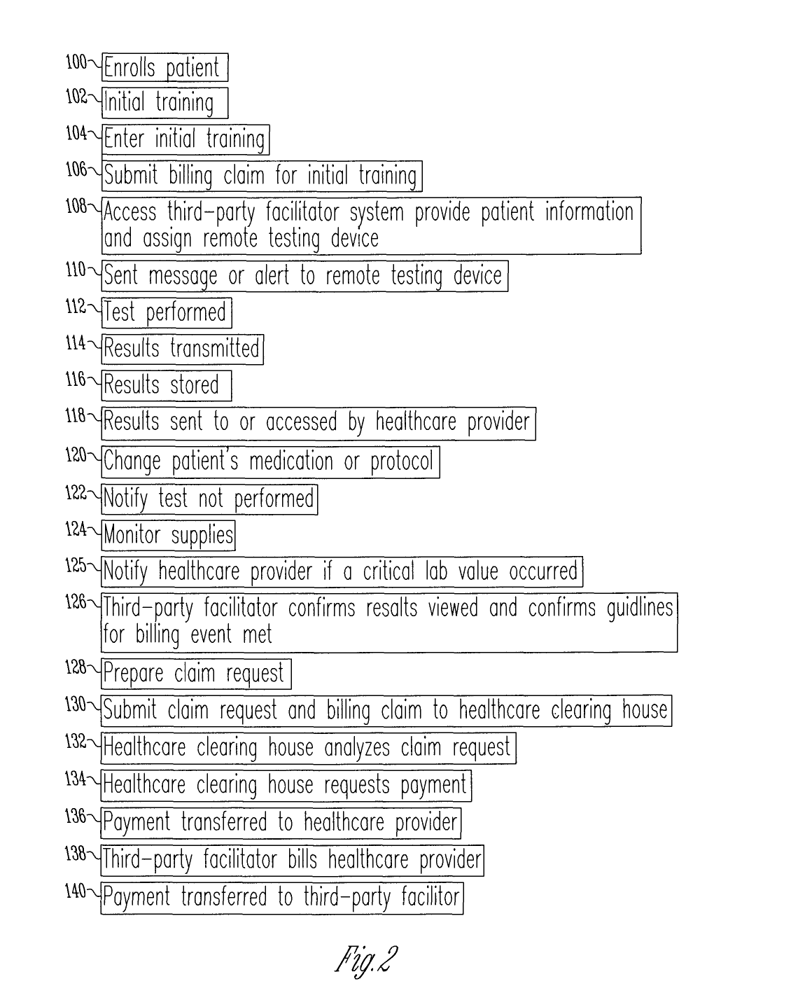

### DETAILED DESCRIPTION OF THE PREFERRED EMBODIMENTS

Referring to the Figures, a remote healthcare monitoring and billing system 10 includes a healthcare provider 12 that involves physicians, nurses, and other healthcare personnel in the diagnosis and treatment of healthcare issues and a third party facilitator 24. The healthcare provider 12 has a practice management system 14 that includes a processor 16 for operating software 18, storing data in a database 20, and displaying information on a monitor 22 or the like.

The practice management system 14 is connected via an electronic network 23, such as the Internet, with a third-party facilitator system 24 that similarly includes a processor 26 for operating facilitator software 28, a database 29 for storing information and displaying information on a monitor 30 and/or a secure website 32.

The third-party facilitator system 24 enables the healthcare provider 12 to enroll patients 33, review and monitor patient results 34, as well as produce patient management reports 36, produce claim requests 38, submit billing 40 to the healthcare provider 12 or on behalf of healthcare provider 12, and manage remote testing devices 46, manage inventory supplies 42 and record and store patient results 44.

The third-party facilitator system 24 is connected via the electronic network 23 with remote testing device 46. A billing claim 48 is either billed through a network 50 of third-party facilitator 24, or billed through a network 52 of the healthcare provider 12 using the data collected through the third-party facilitator 24. The billing claim 48 is paid by a healthcare clearing house 54 through established processes.

In operation, at step 100, the healthcare provider 12 enrolls a patient 33 in the system 10. At step 102, the healthcare provider 12 performs initial office training with the patient 33 with respect to the operation of the remote testing device 46. At step 104, information related to the initial training is entered into the practice management system 14 and the third party facilitator system 24 to automatically trigger a billing claim 48 for the initial training is submitted to a healthcare clearing house 54 for payment at step 106, assuming the training is a billable event.

At step 108, the healthcare provider 12 also accesses the third party facilitator system 24 via the electronic network 23 and enrolls the patient 33 by providing patient information 56 and assigning a remote testing device 46 to the patient 33. Included in the patient information 56 is a protocol 58 that outlines when remote tests are to be conducted.

At step 110, the processor 26 of the third-party facilitator system 24 is capable of sending a message or alert 60 to the patient 33 or directly to the remote testing device 46 as a reminder to perform both a current and/or delinquent remote test. The message is sent to the patient's phone, electronic device and/or the remote testing device 46. Alternatively, the health care provider 12 can access the remote testing device 46 either through third-party facilitator system 24, or directly, and vice versa, that is the remote testing device 46 can provide results or feedback to either or both the third-party facilitator system 24 and/or the health care provider 12, directly or through the other. Alternatively, the message or alert 60 is sent directly to the remote testing device 46. At step 112 a test is performed.

When a test is performed, at step 114, the results 34 are automatically transmitted from the remote testing device 46 to the facilitator system 24 through electronic network 23. At step 116, the results 34 are stored by processor 26 in database 29. At step 118, the results 34 may be automatically sent by the processor 26 to the healthcare provider 12 or may be accessed by the healthcare provider 12 on the secure website 32 of the facilitator. At step 120, based upon review of the results 34, the healthcare provider 12 may change a patient's medication and/or protocol. At step 122, the processor 26 also can notify the healthcare provider 12 if a remote test has not occurred. At step 124, the processor 26 also monitors the supplies 42 used for the remote test and will inform the healthcare provider 12 when additional supplies 42 are needed. At step 125, the processor 26 can notify the healthcare provider 12 if a critical lab value occurred.

At step 126, the third-party facilitator 24 confirms that the results 34 have been reviewed by the healthcare provider 12, and further confirms guidelines have been met for a billing event 62. At step 128, the processor 26 of the third-party facilitator 24 automatically prepares a claim request 38. At step 130, the third-party facilitator 24 submits a claim request 38 and billing claim 48 to healthcare clearing house 54, either directly or through automated reporting to healthcare provider 12. Upon receipt of the claim request 38, healthcare clearing house 54 analyzes the claim request 38 to determine whether it meets the necessary requirement for payment at step 132.

In the event the claim request 38 is verified, at step 132, healthcare clearing house 54 processes the claim request 38 and requests payment of billing claim 48 from healthcare provider 12 at step 134. At step 136, payment is transferred from the insurance company, Medicare, or other payer to the healthcare provider 12 after claim has cleared. At step 138, third-party facilitator 24 bills the healthcare provider 12 for the facilitation of the provider driven model Services under a predetermined contract. At step 140, payment is transferred for these services to third-party facilitator 24.

During this process, the healthcare provider 12 will also have access to various patient and device management reports 44 through the third-party facilitator's secure website 32. These reports will be highly customizable based on the need of the healthcare provider.

What is claimed is:

1. A remote healthcare monitoring and billing system, comprising:
a practice management system operated by a healthcare provider and having a processor, software, a database, and a monitor;
a third party facilitator system connected to the practice management system via the electronic network and has a processor, software, a database, and a monitor;
a remote testing device assigned to and used by a patient that automatically transmits test results to the third party facilitator system via the electronic network upon completion of a test; and
a healthcare clearing house that processes and pays claim requests that are automatically generated by the third party facilitator system upon completion of a healthcare provider's review of the transmitted test results.

2. The system of claim 1 wherein the healthcare provider accesses the test results via a secured website connected to the third party facilitator system.

3. The system of claim 1 wherein the test results are automatically transmitted via the electronic network to the practice management system.

4. The system of claim 1 wherein the third party facilitator system sends and alert notification of an upcoming test.

5. The system of claim 4 wherein the alert is sent to the patient.

6. The system of claim 4 wherein the alert is sent to the remote testing device.

7. The system of claim 4 wherein the alert is sent to the healthcare provider.

8. The system of claim 4 wherein an alert is sent if performance of the test is delinquent.

9. The system of claim 1 wherein the third party facilitator system sends an alert notification to the healthcare provider when a scheduled test is not performed.

10. The system of claim 1 wherein the third party facilitator system monitors supplies used by the patient to perform the test and notifies the healthcare provider when supplies fall below a threshold level.

11. The system of claim 1 wherein the third party facilitator system determines if billing guidelines have been met.

12. The system of claim 1 wherein the third party facilitator system automatically sends a billing claim to the healthcare clearing house via the electronic network when billing guidelines have been met.

13. The system of claim 1 wherein the healthcare clearing house transfers funds to the healthcare provider.
